(19) United States
(12) Patent Application Publication
(10) Pub. No.: US 2020/0406898 A1
(43) Pub. Date: Dec. 31, 2020

(54) FRICTION COEFFICIENT ESTIMATION APPARATUS, VEHICLE CONTROL APPARATUS, AND FRICTION COEFFICIENT ESTIMATION METHOD

(71) Applicant: MITSUBISHI ELECTRIC CORPORATION, Tokyo (JP)

(72) Inventor: Tatsuya MITSUGI, Tokyo (JP)

(73) Assignee: MITSUBISHI ELECTRIC CORPORATION, Tokyo (JP)

(21) Appl. No.: 16/968,510

(22) PCT Filed: Mar. 30, 2018
(86) PCT No.: PCT/JP2018/013710

§ 371 Date: Aug. 7, 2020

(51) Int. Cl. B60W 40/068; B60W 30/18; B60W 30/09; B60W 10/18; B60T 8/172; B60T 8/175

(52) U.S. Cl. CPC B60W 40/068; B60W 30/18109; B60W 30/18172; B60W 30/09; B60W 10/18; B60T 2210/12; B60T 8/175; B60W 2552/40; B60W 2520/26; B60W 2520/105; B60T 8/172

(57) ABSTRACT

It is an object of the present invention to provide a technique that makes it possible to estimate a rolling friction coefficient. A friction coefficient estimation apparatus includes an acquisition unit, a determination unit, and an estimation unit. The acquisition unit acquires the number of tire rotations, a rotation vehicle speed, and slip information. The determination unit determines whether a tire slips or not on the basis of the slip information acquired by the acquisition unit. When the determination unit determines that the tire does not slip, the estimation unit estimates the rolling friction coefficient on the basis of the number of tire rotations and the rotation vehicle speed which are acquired by the acquisition unit.

### TECHNICAL FIELD

The present invention relates to a friction coefficient estimation apparatus, a vehicle control apparatus, and a friction coefficient estimation method for estimating a rolling friction coefficient between a tire and a surface with which the tire is in contact.

### BACKGROUND ART

In recent years, various techniques have been proposed on advanced driver assistance systems (ADAS) of vehicles such as automobiles or the like and automated driving systems (ADS) as an evolution thereof. In these systems, in some cases, used is a device for automatically braking and further stopping an automobile by using a brake or the like.

On the braking of an automobile, a friction force between a tire of the automobile and a road surface has an effect. The friction force is changed by some factors such as “weather”, “the quality of a road surface”, “the quality of a structure of a tire”, “a tread pattern of a tire”, “air pressure of a tire”, “gross vehicle weight”, or the like. Then, the “weather” or “the quality of a road surface” varies from moment to moment, “the quality of a structure of a tire”, the “tread pattern of a tire”, or the “air pressure of a tire” is changed by change of the tire or with time, and the “gross vehicle weight” is changed by the number of passengers and/or luggage weight.

In the advanced driver assistance systems and the automated driving systems, it is required to estimate a friction force or a friction coefficient, at any time, which is changed by some of the above factors and make the braking and stopping appropriate by using the friction force. Further, various techniques have been proposed on the friction (for example, Patent Documents 1 and 2).

### PRIOR ART DOCUMENTS

### Patent Documents

[Patent Document 1] Japanese Patent Application Laid Open Gazette No. 06-239255
[Patent Document 2] Japanese Patent Application Laid Open Gazette No. 11-091538

### SUMMARY

### Problem to be Solved by the Invention

As to the friction between a tire of an automobile during traveling and a surface such as a road surface, there are a rolling friction generated when the tire is rotating and a kinetic friction generated when the tire is not rotating. In the background art, while a coefficient of kinetic friction (kinetic friction coefficient) is estimated, a coefficient of rolling friction (rolling friction coefficient) is not estimated and the rolling friction coefficient is not reflected on the braking of a vehicle, or the like. Therefore, there is room for improvement for the control over the traveling of the vehicle.

Then, the present invention is intended to solve such a problem as described above, and it is an object of the present invention to provide a technique that makes it possible to estimate the rolling friction coefficient.

### Means to Solve the Problem

The present invention is intended for a friction coefficient estimation apparatus. According to the present invention, the friction coefficient estimation apparatus includes an acquisition unit for acquiring the number of rotations of a tire of a vehicle per unit time, a speed of the vehicle per unit time on the basis of the rotation of the tire of the vehicle, and slip information used for determining a slip of the tire, a determination unit for determining whether the tire slips or not on the basis of the slip information acquired by the acquisition unit, and an estimation unit for estimating a rolling friction coefficient between the tire and a surface with which the tire is in contact, on the basis of the number of rotations and the speed which are acquired by the acquisition unit, when the determination unit determines that the tire does not slip.

### Effects of the Invention

According to the present invention, when the determination unit determines that a tire does not slip, the rolling friction coefficient between the tire and a surface with which the tire is in contact is estimated on the basis of the number of rotations and the speed which are acquired. It is thereby possible to improve, for example, the control over the traveling of a vehicle.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram showing a constitution of a friction coefficient estimation apparatus according to a first preferred embodiment;

FIG. 2 is a view showing a state which is a target whose friction coefficient is estimated by the friction coefficient estimation apparatus according to the first preferred embodiment;

FIG. 3 is a block diagram showing a constitution of a friction coefficient estimation apparatus according to a second preferred embodiment;

FIG. 4 is a view showing a state which is a target whose friction coefficient is estimated by the friction coefficient estimation apparatus according to the second preferred embodiment;

FIG. 5 is a flowchart showing an operation of the friction coefficient estimation apparatus according to the second preferred embodiment;

FIG. 6 is a block diagram showing a constitution of a friction coefficient estimation apparatus according to a third preferred embodiment;

FIG. 7 is a view showing a state which is a target whose friction coefficient is estimated by the friction coefficient estimation apparatus according to the third preferred embodiment;

FIG. 8 is another view showing the state which is a target whose friction coefficient is estimated by the friction coefficient estimation apparatus according to the third preferred embodiment;

FIG. 9 is a flowchart showing an operation of the friction coefficient estimation apparatus according to the third preferred embodiment;

FIG. 10 is a block diagram showing a constitution of a vehicle control apparatus according to a modification;

FIG. 11 is a block diagram showing another constitution of the vehicle control apparatus according to the modification;

FIG. 12 is a block diagram showing a hardware constitution of a friction coefficient estimation apparatus according to one of other modifications;

FIG. 13 is a block diagram showing a hardware constitution of the friction coefficient estimation apparatus according to the one of other modifications;

FIG. 14 is a block diagram showing a constitution of a server according to the one of other modifications; and

FIG. 15 is a block diagram showing a constitution of a communication terminal according to the one of other modifications.

### DESCRIPTION OF EMBODIMENTS

### The First Preferred Embodiment

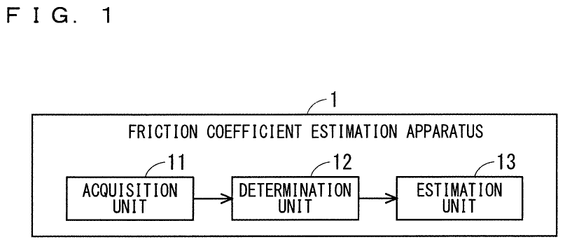

FIG. 1 is a block diagram showing a constitution of a friction coefficient estimation apparatus 1 according to the first preferred embodiment of the present invention. The friction coefficient estimation apparatus 1 shown in FIG. 1 comprises an acquisition unit 11, a determination unit 12, and an estimation unit 13. As described below, this friction coefficient estimation apparatus 1 can estimate (calculate) a rolling friction coefficient between a tire of a vehicle and a surface (for example, a road surface) with which the tire is in contact.

The acquisition unit 11 acquires the number of rotations of the tire of the vehicle per unit time (hereinafter, referred to as the “number of tire rotations”), a speed of the vehicle per unit time (hereinafter, referred to as a “rotation vehicle speed”) on the basis of the rotation of the tire of the vehicle, and slip information used for determining a slip of the tire. The acquisition unit 11 may be constituted of, for example, a wheel speed sensor for detecting the number of tire rotations, a vehicle speed sensor for detecting the rotation vehicle speed, and various sensors of the vehicle, which detect the slip information, or may be constituted of interfaces of these sensors.

The determination unit 12 determines whether the tire of the vehicle slips or not, in other words, whether the tire slips on the road surface or not, on the basis of the slip information acquired by the acquisition unit 11. For this determination, for example, determination which will be described in the second preferred embodiment or the like can be used.

When the determination unit 12 determines that the tire does not slip, the estimation unit 13 estimates the rolling friction coefficient between the tire and the road surface on the basis of the number of tire rotations and the rotation vehicle speed which are acquired by the acquisition unit 11. The estimation unit 13 may estimate the rolling friction coefficient, for example, by using the following equation (1) with the number of tire rotations and the rotation vehicle speed which are acquired by the acquisition unit 11.

Alternatively, the estimation unit 13 may estimate the rolling friction coefficient in accordance with a table in which the number of tire rotations and the rotation vehicle speed are associated with the rolling friction coefficient in advance, on the basis of the number of tire rotations and the rotation vehicle speed which are acquired by the acquisition unit 11. The same applies to estimation of the rolling friction coefficient in various states described hereafter.

$$μ = \frac{{V}_{d} \times {T}_{d}^{2} \times {m}_{1}}{4 \times g \times {m}_{2}} \qquad ( 1 )$$

Further, in equation (1), μ represents the rolling friction coefficient between the tire and the road surface, T_{d} represents the number of tire rotations, V_{d} represents the rotation vehicle speed, m₁ represents a mass exerted on one tire, including a mass of the tire, and m₂ represents a gross vehicle weight. Though the above equation expresses a calculation result for one tire, an ordinary vehicle has four tires and a friction of four tires is a total friction of an automobile. Assuming, however, that the calculation result for one tire is the same as that for any one of the remaining tires, it may be set that m₁=m₂ in the above equation and the following equations. In the following description, it is assumed that m₁ and m₂ are predetermined design values, but these values may be changed as appropriate.

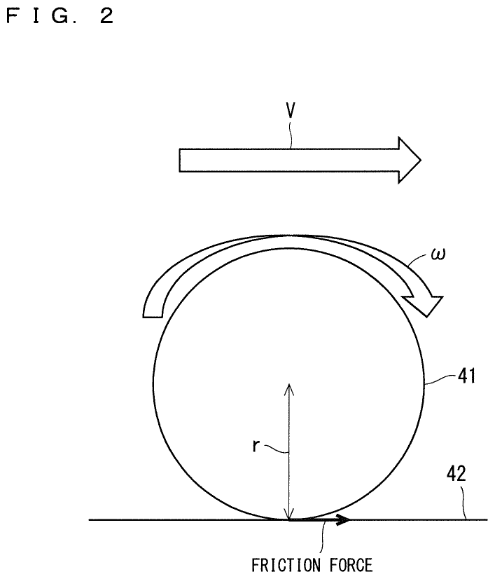

Next, derivation of equation (1) will be described. As shown in FIG. 2, a kinetic energy in a state where a vehicle on which no force other than acceleration of gravity is exerted is traveling on a road surface 42 having no tilt while rotating tires 41 is expressed as the following equation (2) using a moment of inertia I of the tire and an angular velocity ω of the tire.

½×I×ω² (2)

Therefore, a kinetic energy with a change of angular velocity ω_{d} per unit time is expressed as the following equation (3).

½×I×ω_{d}² (3)

Since the kinetic energy is also expressed as N×α by using a moment N due to a rolling friction force and a rotation angle α of the tire, a relation indicated by the following equation (4) can be held.

½×I×ω_{d}²=N×α (4)

The angular velocity ω and the rotation angle α are expressed as the following equations (5) and (6) using the number of rotations T of the tire of the vehicle.

$$\begin{matrix}ω = 2 \times π \times T & ( 5 ) \\ α = \frac{2 \times π}{T} & ( 6 )\end{matrix}$$

Assuming that the moment of inertia I of the tire is approximately a moment of inertia of a circular cylinder, the moment of inertia I of the tire is expressed as the following equation (7) using a mass m₁ exerted on one tire, including a mass of the tire, and a radius r of the tire.

I=½×m₁×r² (7)

The moment N due to the rolling friction force is expressed as following equation (8) using the rolling friction coefficient μ between the tire and the road surface, the gross vehicle weight m₂, the radius r of the tire, and acceleration of gravity g.

N=μ×m₂×g×r (8)

The speed in a circumferential direction of an outer peripheral portion of the tire, i.e., a vehicle speed V is expressed as following equation (9) using the radius r of the tire and the angular velocity ω of the tire.

V=r×ω (9)

When the equation (7) is substituted into I in the equation (4), the equation (8) is substituted into N in the equation (4), the change of angular velocity ω_{d} per unit time is substituted into the angular velocity ω, and a change (difference) α_{d} of the rotation angle per unit time is substituted into the rotation angle α, the following equation (10) is held.

½×(½×m₁×r²)×ω_{d}²=μ×m₂×g×r×α_{d} (10)

When the rolling friction coefficient μ is obtained from an equation held by substituting the number of tire rotations T_{d} which corresponds to α_{d} in the equation (6) and the rotation vehicle speed V_{d} which corresponds to ω_{d} in the equation (9) into the equation (10), the above equation (1) is derived.

### Overview of The First Preferred Embodiment

According to the friction coefficient estimation apparatus 1 of the above-described first preferred embodiment, when the tire of the vehicle does not slip, in other words, when the tire is rotating, the rolling friction coefficient is estimated. With such a configuration, it is possible to estimate the rolling friction coefficient with high accuracy at any time. As a result, since the rolling friction coefficient can be reflected on the braking of the vehicle or the like, it becomes possible to improve the control over the traveling of the vehicle.

### The Second Preferred Embodiment

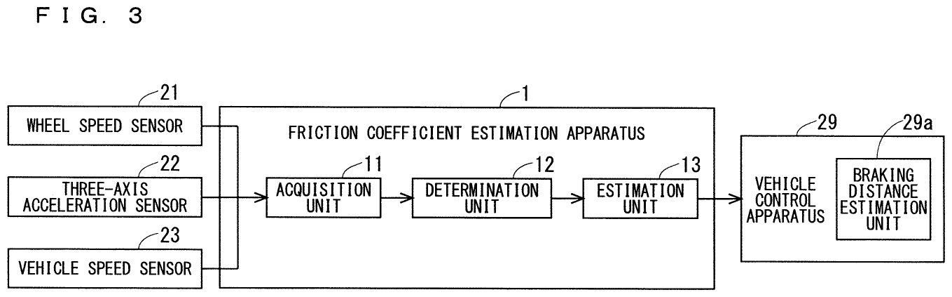

FIG. 3 is a block diagram mainly showing a constitution of a friction coefficient estimation apparatus 1 according to the second preferred embodiment of the present invention. Hereinafter, among constituent elements according to the second preferred embodiment, the constituent elements identical to or similar to those described above will be represented by the same reference signs and different constituent elements will be mainly described.

The friction coefficient estimation apparatus 1 shown in FIG. 3 is connected to a wheel speed sensor 21, a three-axis acceleration sensor 22, a vehicle speed sensor 23, and a vehicle control apparatus 29.

The wheel speed sensor 21 detects the number of rotations of the tire of the vehicle at every unit time, to thereby detect the number of tire rotations described in the first preferred embodiment.

The three-axis acceleration sensor 22 detects a first acceleration, a second acceleration, and a third acceleration in a three-axis direction of the vehicle at every unit time, to thereby detect the first acceleration, the second acceleration, and the third acceleration per unit time. Hereinafter, description will be made on an exemplary case where the first acceleration refers to an acceleration per unit time in a front-back direction of the vehicle (hereinafter, referred to as an “x-axis acceleration”), the second acceleration refers to an acceleration per unit time in a height direction of the vehicle (hereinafter, referred to as a “z-axis acceleration”), and the third acceleration refers to an acceleration per unit time in a left and right direction of the vehicle (hereinafter, referred to as a “y-axis acceleration”).

The vehicle speed sensor 23 detects a speed of the vehicle on the basis of the rotation of the tire of the vehicle at every unit time, to thereby detect the rotation vehicle speed described in the first preferred embodiment.

The friction coefficient estimation apparatus 1 comprises the acquisition unit 11, the determination unit 12, and the estimation unit 13, like in the first preferred embodiment.

The acquisition unit 11 acquires the number of tire rotations detected by the wheel speed sensor 21, the x-axis acceleration, the y-axis acceleration, and the z-axis acceleration which are detected by the three-axis acceleration sensor 22, and the rotation vehicle speed detected by the vehicle speed sensor 23. Further, in the second preferred embodiment, since the slip information used for determining a slip of the tire of the vehicle includes the rotation vehicle speed and the x-axis acceleration, the acquisition unit 11 having the above-described configuration can acquire the slip information.

The determination unit 12 determines whether the tire slips or not on the basis of the rotation vehicle speed and the x-axis acceleration included in the slip information which are acquired by the acquisition unit 11. The determination unit 12 obtains a speed per unit time (hereinafter, referred to as an “acceleration vehicle speed”) in the front-back direction of the vehicle, for example, by integrating the x-axis acceleration. Then, the determination unit 12 determines that the tire does not slip when the acceleration vehicle speed is substantially equal to the rotation vehicle speed, and determines that the tire slips when the acceleration vehicle speed is not substantially equal to the rotation vehicle speed.

The determination unit 12 determines whether or not any force other than gravity is exerted on the vehicle, on the basis of the x-axis acceleration, the y-axis acceleration, and the z-axis acceleration which are acquired by the acquisition unit 11. The determination unit 12 determines, for example, whether the following equation (11) is held or not as to the x-axis acceleration aₓ, the y-axis acceleration a_{y}, and the z-axis acceleration a_{z} which are acquired by the acquisition unit 11. Further, the right side of the following equation (11) is normalized by the acceleration of gravity g. The determination unit 12 determines that no force other than the gravity is exerted on the vehicle when the following equation (11) is held, and the determination unit 12 determines that some force other than the gravity is exerted on the vehicle when the following equation (11) is not held.

\sqrt{αₓ²+α_{y}²+α_{z}²}=1 (11)

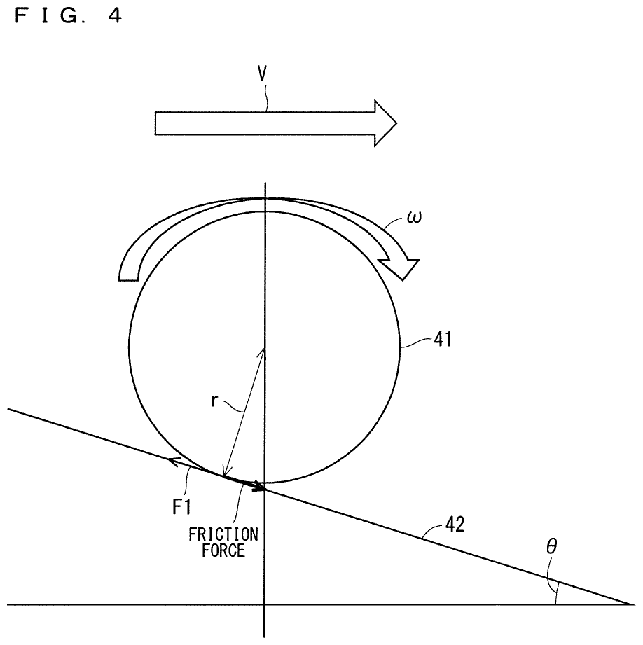

As shown in FIG. 4, when the vehicle on which no force other than the acceleration of gravity is exerted is traveling on the road surface 42 having a tilt angle θ while rotating the tires 41, a relation indicated by the following equation (12) can be held, instead of the above equation (4).

½×I×ω_{d}²=(N−F1×r)×α (12)

F1 is a force due to a tilt of the road surface 42 and expressed as the following equation (13) using the tilt angle θ of the road surface 42, the acceleration of gravity g, and the like.

F1=m₂×g×cos θ (13)

The tilt angle θ of the road surface 42, i.e., a tilt around the y axis is expressed as the following equation (14) using the x-axis acceleration aₓ and the z-axis acceleration a_{z}.

$$θ = {tan}^{- 1} ( \frac{{a}_{x}}{{a}_{z}} ) \qquad ( 14 )$$

When the rolling friction coefficient μ is obtained from an equation held by substituting the above equations (12) and (13) into the above equation (11), the following equation (15) is derived.

$$μ = cos ( {tan}^{- 1} ( \frac{{a}_{x}}{{a}_{z}} ) ) + \frac{{V}_{d} \times {T}_{d}^{2} \times {m}_{1}}{4 \times g \times {m}_{2}} \qquad ( 15 )$$

When the determination unit 12 determines that the tire of the vehicle does not slip and the determination unit 12 determines that no force other than the gravity is exerted on the vehicle, the estimation unit 13 estimates the rolling friction coefficient by using the above equation (15) with the number of tire rotations, the rotation vehicle speed, the x-axis acceleration aₓ, and the z-axis acceleration a_{z} which are acquired by the acquisition unit 11. In other words, in the present second preferred embodiment, the estimation unit 13 uses the x-axis acceleration aₓ and the z-axis acceleration a_{z} which are acquired by the acquisition unit 11, for the above-described estimation of the rolling friction coefficient.

The vehicle control apparatus 29 comprises a braking distance estimation unit 29a. The braking distance estimation unit 29a obtains a braking distance of the vehicle on the basis of the rolling friction coefficient estimated by the friction coefficient estimation apparatus 1. The vehicle control apparatus 29 controls the traveling of the vehicle on the basis of the braking distance obtained by the braking distance estimation unit 29a and a free running distance of the vehicle. The vehicle control apparatus 29 having such a configuration can control the traveling of the vehicle on the basis of the rolling friction coefficient estimated by the friction coefficient estimation apparatus 1.

Herein, the free running distance is a distance which the vehicle travels from when it is determined that a brake should be applied and the command is given to the brake to when the brake starts to work, and the braking distance is a distance which the vehicle travels from when the brake starts to work to when the vehicle is stopped. A stopping distance D of the vehicle is expressed as the following equation (16) using the free running distance Dj and the braking distance Db.

D=Dj+Db (16)

The free running distance Dj is expressed as the following equation (17) using a determination time tj or an operation time tc by a CPU (Central Processing Unit) from when an input from a sensor such as a camera or the like is received to when the command is given to the brake and a cycle is at which information is inputted from the sensor to the CPU.

Dj=V×Tj=V×(Ts×Tc) (17)

The braking distance Db is expressed as the following equation (18) using the vehicle speed V, the acceleration of gravity g, and the rolling friction coefficient μ.

$$Db = \frac{{V}^{2}}{2 \times g \times μ} \qquad ( 18 )$$

The stopping distance D of the vehicle is expressed as the following equation (19) by applying the equations (16) and (18) to the equation (16).

$$D = V \times ( Ts \times Tc ) + \frac{{V}^{2}}{2 \times g \times μ} \qquad ( 19 )$$

The vehicle control apparatus 29 obtains the stopping distance D of the vehicle by applying the braking distance obtained by the braking distance estimation unit 29a and the rotation vehicle speed acquired by the acquisition unit 11 to the braking distance Db and the vehicle speed V in the above equations and applying predetermined design values to the cycle is and the operation time tc. Then, the vehicle control apparatus 29 controls the braking of the vehicle, the traveling direction thereof, and the like so that the vehicle should not come into contact with any obstacle or controls a distance between the vehicle and any other vehicle on the basis of the stopping distance D of the vehicle.

### Operation

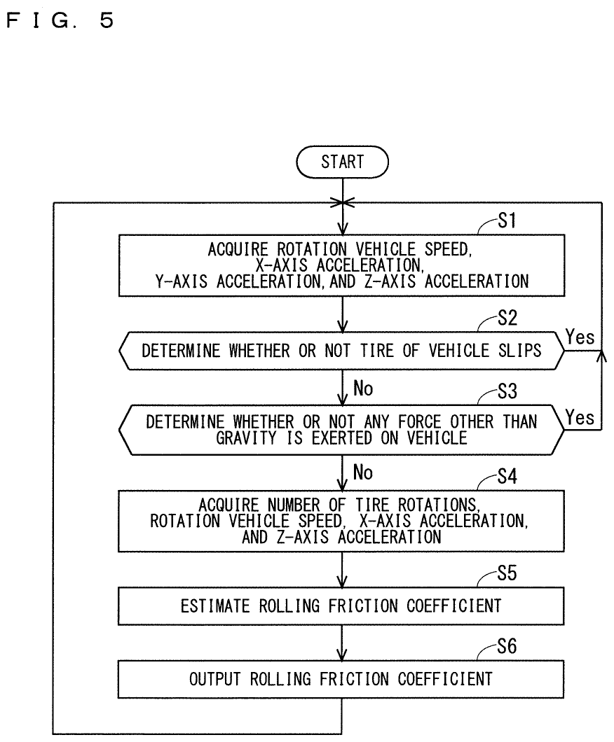

FIG. 5 is a flowchart showing an operation of the friction coefficient estimation apparatus 1 according to the second preferred embodiment.

In Step S1, the acquisition unit 11 acquires the rotation vehicle speed, the x-axis acceleration, the y-axis acceleration, and the z-axis acceleration.

In Step S2, the determination unit 12 determines whether or not the tire of the vehicle slips on the basis of the rotation vehicle speed and the x-axis acceleration which are acquired in Step S1. When it is determined that the tire slips, the process goes back to Step S1, and when it is determined that the tire does not slip, the process goes to Step S3.

In Step S3, the determination unit 12 determines whether or not any force other than the gravity is exerted on the vehicle on the basis of the x-axis acceleration, the y-axis acceleration, and the z-axis acceleration which are acquired in Step S1. When it is determined that some force other than the gravity is exerted on the vehicle, the process goes back to Step S1, and when it is determined that no force other than the gravity is exerted on the vehicle, the process goes to Step S4.

In Step S4, the acquisition unit 11 acquires the number of tire rotations, the rotation vehicle speed, the x-axis acceleration, and the z-axis acceleration. Further, the acquisition unit 11 may acquire the number of tire rotations, the rotation vehicle speed, the x-axis acceleration, and the z-axis acceleration concurrently, or may acquire, for example, the x-axis acceleration and the z-axis acceleration, the number of tire rotations, and the rotation vehicle speed in this order.

In Step S5, the estimation unit 13 estimates the rolling friction coefficient by using the above equation (15) with the number of tire rotations, the rotation vehicle speed, the x-axis acceleration, and the z-axis acceleration which are acquired in Step S4.

In Step S6, the friction coefficient estimation apparatus 1 outputs the estimated rolling friction coefficient to the vehicle control apparatus 29. The vehicle control apparatus 29 controls the traveling of the vehicle on the basis of the rolling friction coefficient outputted from the friction coefficient estimation apparatus 1. After that, the process goes back to Step S1.

### Overview of The Second Preferred Embodiment

According to the friction coefficient estimation apparatus 1 of the above-described second preferred embodiment, when it is determined that no force other than the gravity is exerted on the vehicle, the rolling friction coefficient is estimated. With such a configuration, it is possible to estimate the rolling friction coefficient with high accuracy.

Further, according to the friction coefficient estimation apparatus 1 of the present second preferred embodiment, the x-axis acceleration and the z-axis acceleration are used to estimate the rolling friction coefficient. With such a configuration, it is possible to estimate the rolling friction coefficient with high accuracy in the case where the vehicle is traveling on a road surface having a tilt.

Furthermore, according to the vehicle control apparatus 29 of the present second preferred embodiment, since the traveling of the vehicle is controlled on the basis of the rolling friction coefficient estimated by the friction coefficient estimation apparatus 1, it is possible to improve the control over the traveling of the vehicle.

### The Third Preferred Embodiment

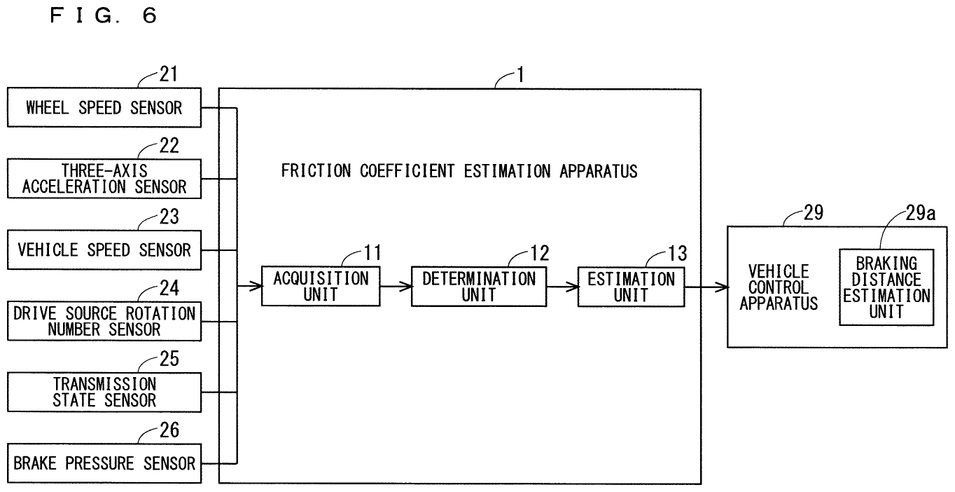

FIG. 6 is a block diagram mainly showing a constitution of a friction coefficient estimation apparatus 1 according to the third preferred embodiment of the present invention. Hereinafter, among constituent elements according to the third preferred embodiment, the constituent elements identical to or similar to those described above will be represented by the same reference signs and different constituent elements will be mainly described.

The friction coefficient estimation apparatus 1 shown in FIG. 6 is connected not only to the wheel speed sensor 21 and the like but also to a drive source rotation number sensor 24, a transmission state sensor 25, and a brake pressure sensor 26.

The drive source rotation number sensor 24 detects the number of rotations of a drive source. Herein, the drive source includes at least one of an engine and a motor of the vehicle. The transmission state sensor 25 detects a gear ratio in transmission of the vehicle. The brake pressure sensor 26 detects a brake pressure of the vehicle per unit time.

The acquisition unit 11 acquires a driving force which drives the vehicle, on the basis of the number of rotations detected by the drive source rotation number sensor 24 and the gear ratio detected by the transmission state sensor 25. For example, the acquisition unit 11 may acquire the driving force in accordance with a table in which the number of rotations and the gear ratio are associated with the driving force in advance, on the basis of the number of rotations detected by the drive source rotation number sensor 24 and the gear ratio detected by the transmission state sensor 25.

Further, the acquisition unit 11 acquires a braking force which brakes the vehicle on the basis of the brake pressure detected by the brake pressure sensor 26. For example, the acquisition unit 11 may acquire the braking force in accordance with a table in which the brake pressure is associated with the braking force in advance, on the basis of the brake pressure detected by the brake pressure sensor 26.

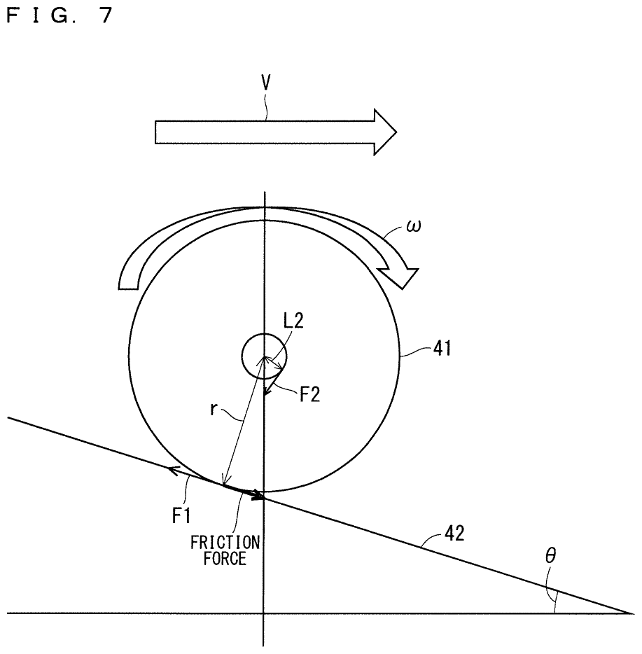

As shown in FIG. 7, when the vehicle to which the driving force is applied is traveling on the road surface 42 having the tilt angle θ while rotating the tires 41, a relation indicated by the following equation (20) can be held, instead of the above equation (12).

½×I×ω_{d}²=(N−F1×r−F2×L2))×α (20)

F2 is a driving force and L2 is a radius of a cross section of a shaft which transmits the driving force. Further, F2×L2 corresponds to a moment N2 of the driving force. When the rolling friction coefficient μ is obtained from this equation, like in the equation (15), the following equation (21) is derived.

$$μ = cos ( {tan}^{- 1} ( \frac{{a}_{x}}{{a}_{z}} ) ) - \frac{2 \times π \times {T}_{d} \times F 2 \times L 2}{{m}_{2} \times g \times {V}_{d}} + \frac{{V}_{d} \times {T}_{d}^{2} \times {m}_{1}}{4 \times g \times {m}_{2}} \qquad ( 21 )$$

When the determination unit 12 determines that the tire of the vehicle does not slip, the estimation unit 13 estimates the rolling friction coefficient by using the above equation (21) with the number of tire rotations, the rotation vehicle speed, the x-axis acceleration aₓ, the z-axis acceleration a_{z}, and the driving force F2 which are acquired by the acquisition unit 11. Further, it is assumed that L2 is a predetermined design value, but this value may be changed as appropriate. Thus, in the present third preferred embodiment, the estimation unit 13 uses the driving force F2 acquired by the acquisition unit 11, for the above-described estimation of the rolling friction coefficient.

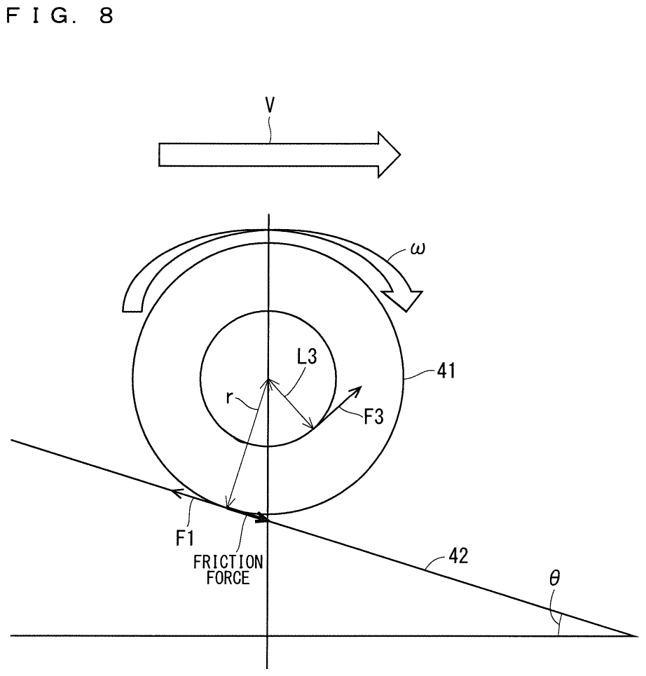

On the other hand, as shown in FIG. 8, when the vehicle to which the braking force is applied is traveling on the road surface 42 having the tilt angle θ while rotating the tires 41, a relation indicated by the following equation (22) can be held, instead of the above equation (12).

½×I×ω_{d}²=(N−F1×r+F3×L3))×α (22)

F3 is a braking force and L3 is a distance to a brake shoe which transmits the braking force. Further, F3×L3 corresponds to a moment N3 of the braking force. When the rolling friction coefficient μ is obtained from this equation, like in the equation (15), the following equation (23) is derived.

$$μ = cos ( {tan}^{- 1} ( \frac{{a}_{x}}{{a}_{z}} ) ) + \frac{2 \times π \times {T}_{d} \times F 3 \times L 3}{{m}_{2} \times g \times {V}_{d}} + \frac{{V}_{d} \times {T}_{d}^{2} \times {m}_{1}}{4 \times g \times {m}_{2}} \qquad ( 23 )$$

When the determination unit 12 determines that the tire of the vehicle does not slip, the estimation unit 13 estimates the rolling friction coefficient by using the above equation (23) with the number of tire rotations, the rotation vehicle speed, the x-axis acceleration aₓ, the z-axis acceleration a_{z}, and the braking force F3 which are acquired by the acquisition unit 11. Further, it is assumed that L3 is a predetermined design value, but this value may be changed as appropriate. Thus, in the present third preferred embodiment, the estimation unit 13 uses the braking force F3 acquired by the acquisition unit 11, for the above-described estimation of the rolling friction coefficient.

### Operation

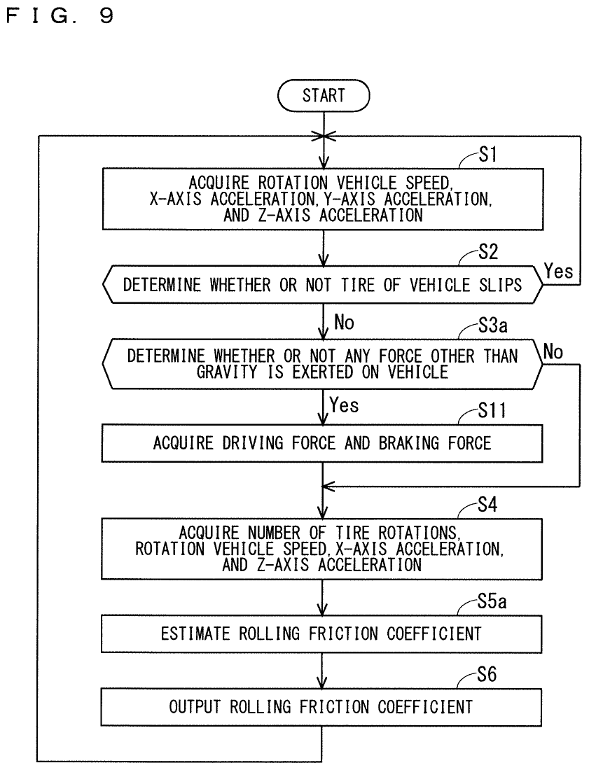

FIG. 9 is a flowchart showing an operation of the friction coefficient estimation apparatus 1 according to the third preferred embodiment. Further, since Steps S1, S2, S4, and S6 in FIG. 9 are the same as those in FIG. 5, respectively, description on these Steps will be omitted as appropriate.

After the operations of Steps S1 and S2 are performed, in Step S3a, the determination unit 12 determines whether or not any force other than the gravity is exerted on the vehicle on the basis of the x-axis acceleration, the y-axis acceleration, and the z-axis acceleration which are acquired in Step S1. When it is determined that some force other than the gravity is exerted on the vehicle, the process goes to Step S11, and when it is determined that no force other than the gravity is exerted on the vehicle, the process goes to Step S4.

In Step S11, the acquisition unit 11 acquires the driving force and the braking force. After that, the process goes to Step S4.

After the operation of Step S4 is performed, an operation of Step S5a is performed. When Step S11 is not executed before Step S5a, the estimation unit 13 estimates the rolling friction coefficient by using the above equation (15) with the number of tire rotations, the rotation vehicle speed, the x-axis acceleration, and the z-axis acceleration. When the driving force is acquired in Step S11 before Step S5a, the estimation unit 13 estimates the rolling friction coefficient by using the above equation (21) with the number of tire rotations, the rotation vehicle speed, the x-axis acceleration, the z-axis acceleration, and the driving force. When the braking force is acquired in Step S11 before Step S5a, the estimation unit 13 estimates the rolling friction coefficient by using the above equation (23) with the number of tire rotations, the rotation vehicle speed, the x-axis acceleration, the z-axis acceleration, and the braking force.

After that, the operation of Step S6 is performed and then the process goes back to Step S1.

### Overview of The Thirds Preferred Embodiment

According to the friction coefficient estimation apparatus 1 of the above-described third preferred embodiment, the driving force or the braking force is used to estimate the rolling friction coefficient. With such a configuration, it is possible to estimate the rolling friction coefficient with high accuracy in the case where the driving force or the braking force is exerted on the vehicle. Further, though the driving force or the braking force is used to estimate the rolling friction coefficient in the above description, this is only one exemplary case. In combination of the above equations (21) and (23), for example, the driving force and the braking force may be used to estimate the rolling friction coefficient.

### The First Modification

FIG. 10 is a block diagram mainly showing a constitution of a vehicle control apparatus 29 according to a first modification. The vehicle control apparatus 29 shown in FIG. 10 is unified with the friction coefficient estimation apparatus 1 according to the second preferred embodiment (FIG. 3).

FIG. 11 is a block diagram mainly showing another constitution of the vehicle control apparatus 29 according to the first modification. The vehicle control apparatus 29 shown in FIG. 11 is unified with the friction coefficient estimation apparatus 1 according to the third preferred embodiment (FIG. 6).

According to the vehicle control apparatus 29 of the first modification as described above, since the vehicle control apparatus 29 is unified with the friction coefficient estimation apparatus 1, reduction in the cost is expected.

### The Second Modification

Though the determination unit 12 determines whether the tire slips or not by whether or not the rotation vehicle speed is substantially equal to the acceleration vehicle speed based on the x-axis acceleration in the above description, this is only one exemplary case. The determination unit 12 may determine whether the tire slips or not, for example, by whether or not an acceleration which is obtained by differentiating the rotation vehicle speed is substantially equal to the x-axis acceleration.

Further, though the slip information consists of the rotation vehicle speed and the x-axis acceleration in the above description, this is only one exemplary case. The slip information may consist of, for example, a yaw rate of the vehicle and the x-axis acceleration, or the like.

### Other Modifications

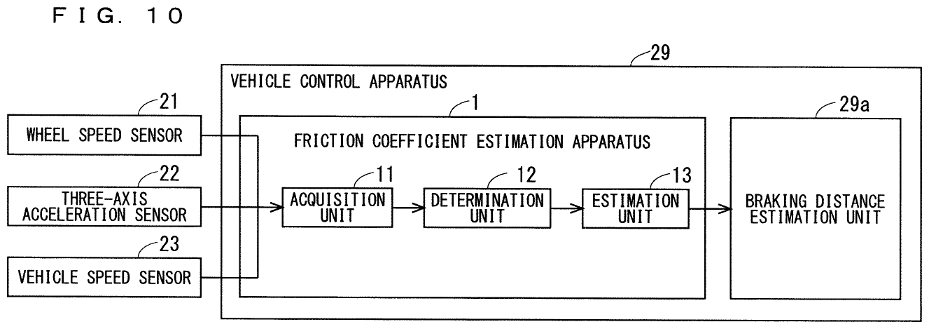

The acquisition unit 11, the determination unit 12, and the estimation unit 13 shown in FIG. 1 and described above will be hereinafter referred to as “the acquisition unit 11 and the like”. The acquisition unit 11 and the like are implemented by a processing circuit 81 shown in FIG. 12. Specifically, the processing circuit 81 comprises the acquisition unit 11 for acquiring the number of tire rotations, the rotation vehicle speed, and the slip information, the determination unit 12 for determining whether the tire slips or not on the basis of the slip information acquired by the acquisition unit 11, the estimation unit 13 for estimating the rolling friction coefficient on the basis of the number of tire rotations and the rotation vehicle speed which are acquired by the acquisition unit 11 in the case where the determination unit 12 determines that the tire does not slip. To the processing circuit 81, a dedicated hardware may be applied, or a processor which executes a program stored in a memory may be applied. As the processor, for example, used is a central processing unit (CPU), a processing unit, an estimation apparatus, a microprocessor, a microcomputer, a DSP (Digital Signal Processor), or the like.

When the processing circuit 81 is a dedicated hardware, the processing circuit 81 corresponds to, for example, a single circuit, a complex circuit, a programmed processor, a multiple programmed processor, an ASIC (Application Specific Integrated Circuit), an FPGA (Field Programmable Gate Array), or a combination of these circuits. Respective functions of the constituent elements such as the acquisition unit 11 and the like may be implemented by circuits into which the processing circuit is decentralized, or these functions may be collectively implemented by one processing circuit.

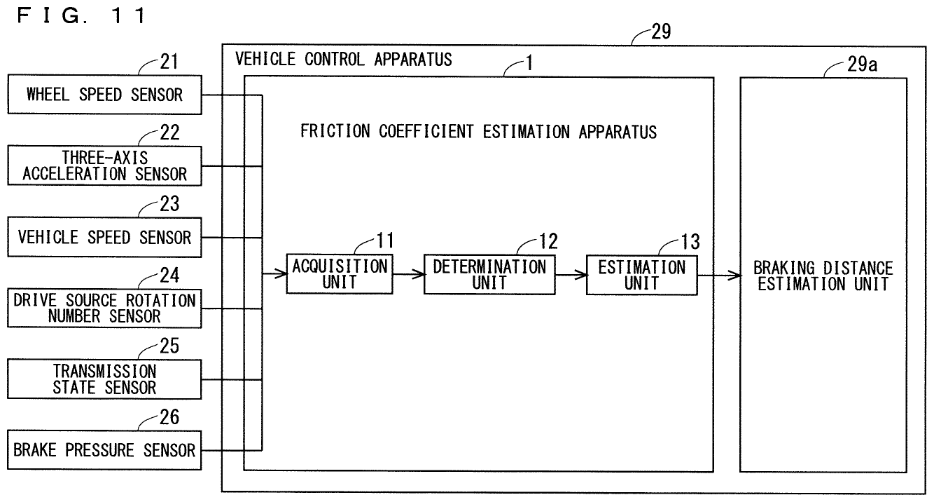

When the processing circuit 81 is a processor, the functions of the acquisition unit 11 and the like are implemented by combination with software or the like. The software or the like corresponds to, for example, software, firmware, or software and firmware. The software or the like is described as a program and stored in a memory. As shown in FIG. 13, a processor 82 applied to the processing circuit 81 reads out and executes the program stored in a memory 83, to thereby implement the respective functions of the constituent elements. Specifically, the friction coefficient estimation apparatus 1 comprises the memory 83 which stores therein programs which are executed by the processing circuit 81 to consequently perform the steps of acquiring the number of tire rotations, the rotation vehicle speed, and the slip information, determining whether the tire slips or not on the basis of the acquired slip information, and estimating the rolling friction coefficient on the basis of the number of tire rotations and the rotation vehicle speed which are acquired when it is determined that the tire does not slip. In other words, the program is executed to cause a computer to perform a procedure or a method of the acquisition unit 11 and the like. Herein, the memory 83 may be, for example, a nonvolatile or volatile semiconductor memory such as a RAM (Random Access Memory), a ROM (Read Only Memory), a flash memory, an EPROM (Erasable Programmable Read Only Memory), an EEPROM (Electrically Erasable Programmable Read Only Memory), or the like, a HDD (Hard Disk Drive), a magnetic disk, a flexible disk, an optical disk, a compact disk, a mini disk, or a DVD (Digital Versatile Disc) and a drive unit thereof, or the like, or every storage medium which can be used in the future.

The case has been described above where the respective functions of the acquisition unit 11 and the like are implemented by one of hardware and software or the like. This is, however, only one exemplary case. There may be a case where some part of the acquisition unit 11 and the like is implemented by a dedicated hardware and the other part is implemented by software or the like. For example, the function of the acquisition unit 11 can be implemented by the processing circuit 81 as the dedicated hardware and a receiver or the like, and the respective functions of the other constituent elements can be implemented when the processing circuit 81 serving as the processor 82 reads out and executes the program stored in the memory 83.

Thus, the processing circuit 81 can implement the above-described functions by hardware, software or the like, or combination thereof.

Further, the above-described friction coefficient estimation apparatus 1 can be also applied to a friction coefficient estimation system which is configured as a system by combining, as appropriate, a navigation device such as a PND (Portable Navigation Device) or the like, a communication terminal including a portable terminal such as a cellular phone, a smartphone, a tablet, or the like, a function of an application installed in at least one of the navigation device and the communication terminal, and a server. In this case, the functions or the constituent elements in the above-described friction coefficient estimation apparatus 1 may be arranged, being decentralized into these devices constituting the system, or may be arranged, being centralized into any one device.

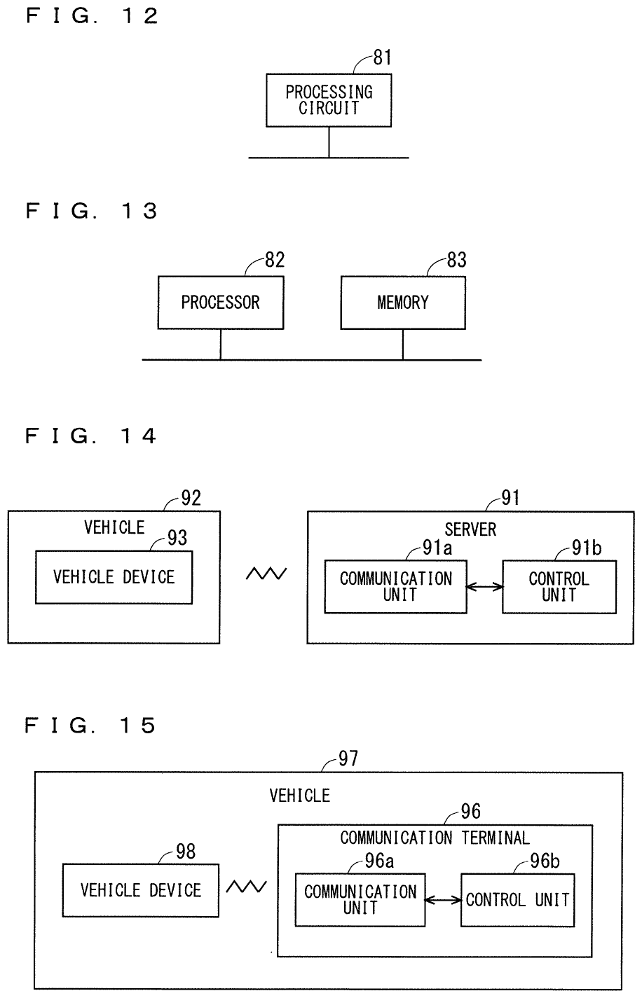

FIG. 14 is a block diagram showing a constitution of a server 91 according to the present modification. The server 91 shown in FIG. 14 comprises a communication unit 91a and a control unit 91b, and can perform wireless communication with a vehicle device 93 such as a navigation device or the like of a vehicle 92.

The communication unit 91a serving as the acquisition unit performs wireless communication with the vehicle device 93, to thereby receive the number of tire rotations, the rotation vehicle speed, and the slip information which are acquired by the vehicle device 93.

The control unit 91b has the same function as that of the determination unit 12 and the estimation unit 13 shown in FIG. 1 when a not-shown processor or the like in the server 91 executes a program stored in a not-shown memory in the server 91. Specifically, the control unit 91b determines whether the tire slips or not on the basis of the slip information received by the communication unit 91a, and when it is determined that the tire does not slip, the control unit 91b estimates the rolling friction coefficient on the basis of the number of tire rotations and the rotation vehicle speed which are received by the communication unit 91a. Then, the communication unit 91a transfers the rolling friction coefficient estimated by control unit 91b to the vehicle device 93. According to the server 91 having such a configuration, it is possible to produce the same effect as that produced by the friction coefficient estimation apparatus 1 described in the first preferred embodiment.

FIG. 15 is a block diagram showing a constitution of a communication terminal 96 according to the present modification. The communication terminal 96 shown in FIG. 15 comprises a communication unit 96a like the communication unit 91a and a control unit 96b like the control unit 91b, and can perform wireless communication with a vehicle device 98 of a vehicle 97. Further, to the communication terminal 96, applied is, for example, a portable terminal such as a cellular phone, a smartphone, a tablet, or the like, which a driver of the vehicle 97 carries. Thus, according to the communication terminal 96 having such a configuration, it is possible to produce the same effect as that produced by the friction coefficient estimation apparatus 1 described in the first preferred embodiment.

Further, in the present invention, the preferred embodiments and the modifications may be freely combined, or may be changed or omitted as appropriate, without departing from the scope of the invention.

While the invention has been shown and described in detail, the foregoing description is in all aspects illustrative and not restrictive. It is therefore understood that numerous modifications and modifications can be devised without departing from the scope of the invention.

### EXPLANATION OF REFERENCE SIGNS

1 friction coefficient estimation apparatus, 11 acquisition unit, 12 determination unit, 13 estimation unit, 29 vehicle control apparatus, 41 tire, 42 road surface

1. A friction coefficient estimation apparatus, comprising:
a processor to execute a program; and
a memory to store the program which, when executed by the processor, performs
an acquisition process for acquiring the number of rotations of a tire of a vehicle per unit time, a speed of the vehicle on the basis of the rotation of the tire of the vehicle, and slip information used for determining a slip of the tire;
a determination process for determining whether the tire slips or not on the basis of the slip information acquired by the acquisition process; and
an estimation process for estimating a rolling friction coefficient between the tire and a surface with which the tire is in contact, on the basis of the number of rotations and the speed which are acquired by the acquisition process, when the determination process determines that the tire does not slip.

2. The friction coefficient estimation apparatus according to claim 1, wherein
the acquisition process further acquires a first acceleration, a second acceleration, and a third acceleration in a three-axis direction of the vehicle,
the determination process determines whether or not any force other than gravity is exerted on the vehicle, on the basis of the first acceleration, the second acceleration, and the third acceleration which are acquired by the acquisition process, and
the estimation process estimates the rolling friction coefficient when the determination process determines that no force other than gravity is exerted on the vehicle.

3. The friction coefficient estimation apparatus according to claim 1, wherein
the acquisition process further acquires a first acceleration in a front-back direction of the vehicle and a second acceleration in a height direction of the vehicle, and
the estimation process uses the first acceleration and the second acceleration which are acquired by the acquisition process, to estimate the rolling friction coefficient.

4. The friction coefficient estimation apparatus according to claim 1, wherein
the acquisition process further acquires a driving force for driving the vehicle, and
the estimation process uses the driving force acquired by the acquisition process, to estimate the rolling friction coefficient.

5. The friction coefficient estimation apparatus according to claim 1, wherein
the acquisition process further acquires a braking force for braking the vehicle, and
the estimation process uses the braking force acquired by the acquisition process, to estimate the rolling friction coefficient.

6. The friction coefficient estimation apparatus according to claim 1, wherein
the slip information includes the speed and an acceleration in a front-back direction of the vehicle.

7. A vehicle control apparatus for controlling the traveling of the vehicle on the basis of the rolling friction coefficient which is estimated by the friction coefficient estimation apparatus according to claim 1.

8. The vehicle control apparatus according to claim 7, which obtains a braking distance of the vehicle on the basis of the rolling friction coefficient estimated by the friction coefficient estimation apparatus and controls a distance between the vehicle and any other vehicle on the basis of the braking distance.

9. The vehicle control apparatus according to claim 7, which is unified with the friction coefficient estimation apparatus.

10. A friction coefficient estimation method, comprising:
acquiring the number of rotations of a tire of a vehicle per unit time, a speed of the vehicle on the basis of the rotation of the tire of the vehicle, and slip information used for determining a slip of the tire;
determining whether the tire slips or not on the basis of the slip information which is acquired; and
estimating a rolling friction coefficient between the tire and a surface with which the tire is in contact, on the basis of the number of rotations and the speed which are acquired, when it is determined that the tire does not slip.
